(19) United States
(12) Patent Application Publication
(10) Pub. No.: US 2002/0047079 A1
(43) Pub. Date: Apr. 25, 2002

(54) Rug clip

(76) Inventor: Stuart Gerson, Miramar, FL (US)

Correspondence Address: James W. Jakobsen, 1600 Tysons Boulevard, McLean, VA, 22102, US

(21) Appl. No.: 09/982,360

(22) Filed: Oct. 18, 2001

Related U.S. Application Data
(60) Provisional application No. 60/242,341, filed on Oct. 20, 2000.

(51) Int. Cl. B42F 13/00; A47G 1/10

(52) U.S. Cl. 248/339; 248/316.5

(57) ABSTRACT

The present invention concerns a rug clip for hanging a rug from a door of a display rack. The rug clip includes a channel-shaped bracket including a top portion having a bottom surface, a front leg extending from a first edge of the top portion, and a rear leg extending from a second edge of the top portion opposite the first edge, wherein the front leg and the rear leg are approximately perpendicular in relation to the top portion. A clipping mechanism is mounted to the front leg for gripping the rug. And a non-slip material is attached to the bottom surface of the top portion to prevent the rug clip from sliding off the end of the door when the door is swung about its hinges.

### CROSS-REFERENCE TO RELATED APPLICATION

This application claims the benefit of U.S. Provisional Patent Application No. 60/242,341, filed Oct. 20, 2000.

### BACKGROUND OF THE INVENTION

1. Field of the Invention

The present invention relates to a rug clip, and, more particularly, to a rug clip used on a door of a display rack for hanging a rug, the rug clip having a non-slip material attached thereto for preventing the rug clip from slipping along the top edge of the door as the door is swung about its hinges.

2. Background and Description of Prior Art

Clips are known in the art for hanging rugs on display racks for displaying the rugs to potential customers. The display racks typically include several doors in the form of rectangular metal frames that are hinged to a vertical post. Using such display racks customers may quickly and conveniently review the rugs by separately swinging each door in a manner similar to turning the pages in a book. Rug clips are usually not permanently attached to the doors of display racks, but are instead hooked over the top edge of each door. A disadvantage of this arrangement is that the rug clips tend to slip along the top edge of each door as a customer swings them about their hinges due to centrifugal forces. If rug clips supporting a rug slip off the top edge of a door, a salesperson must take the time to re-hang the rug onto the door. Worse yet, a customer may be injured when the rug falls from the door. This is especially a danger when the rug clips are supporting a large area rug.

The prior art discloses devices for hanging various objects over rods, doors, and the like, however, none of the prior art discloses a way to prevent rug clips from sliding along the top edge of a door of a display rack when the door is swung about its hinges. Such prior art disclosures are described below.

U.S. Pat. No. 2,633,321 to Coulter discloses a drapery supporting device including a pair of jaw members pivoted together intermediate their ends, a spring operatively connected with the jaw members and urging the members together, a hook for suspending the jaw members, the hook including a shank having an eye at one end and a pivot pin fixed to one of the jaw members and being located in the eye to thereby pivotally connect the hook to the one of the jaw members. The hook is intended to be hung over a drapery rod and the jaw members are intended to grip the top edge of a drape.

Coulter does not disclose a device for preventing the hook from sliding along the length of a drapery rod. In fact, it is a preferable aspect of the invention that the hook does slide along the length of a drape rod so the drape can be easily drawn open or closed to let light into or close light off from, respectively, a room.

U.S. Pat. No. 5,535,971 to Adams discloses a door hook which is thin enough to fit between the top of a door and a door jamb and strong enough to hold significant weight when the door is opened. The door hook is comprised of a U-shaped bracket, a compressible pad and a hook. More specifically, the door hook includes a top having a bottom surface, a front side having a hook and a back side. The front side is attached to one edge of the top at an acute angle relative to the bottom surface of the top. The compressible pad is attached to the bottom surface of the top. The compressible pad has a releasable adhesive. The door hook is intended to provide increased holding power, for example, of up to ten times that of a door hook with no acute angles and no compressible pad.

The door hook disclosed by Adams cannot be used to hold carpets (except those that may happen to have loops along their top edge, which is unusual). Furthermore, the door hook is not intended to prevent the hook from sliding along the length of the top edge of a door.

The disclosures of U.S. Pat. No. 2,633,321 and U.S. Pat. No. 5,535,971 are incorporated by reference in their entirety herein.

From the above, it is clear that there is a need in the art for a rug clip that will not slide along the top edge of the doors of a display rack when the doors are swung about their hinges. Such a device will at the least prevent the need for a salesperson from having to re-hang rugs that fall from their display racks and at the most prevent a customer from becoming injured if a rug falls from the display rack onto the customer.

### DESCRIPTION OF THE DRAWINGS

So that those having ordinary skill in the art to which the subject invention appertains will more readily understand how to make and use the rug clip described herein, preferred embodiments of the invention will be described in detail herein below with reference to the drawings wherein:

FIG. 1 is a prospective view of a door of a display rack on which rug clips of the present invention are to be mounted for hanging a rug;

FIG. 2 is an elevational view of a rug clip mounted to a door and poised for clipping a rug in a hanging position; and

FIG. 3 is an elevational view of a rug clip mounted to a door that has been clipped onto a rug for hanging the rug.

### DETAILED DESCRIPTION OF THE PREFERRED EMBODIMENTS

As described above, rug clips are known in the art for hanging rugs on the doors of a display rack for displaying the rugs to potential customers. The present invention discloses a rug clip that has been improved to eliminate the problem of its slipping along the top edge of the doors of the display rack as a customer swings them about their hinges.

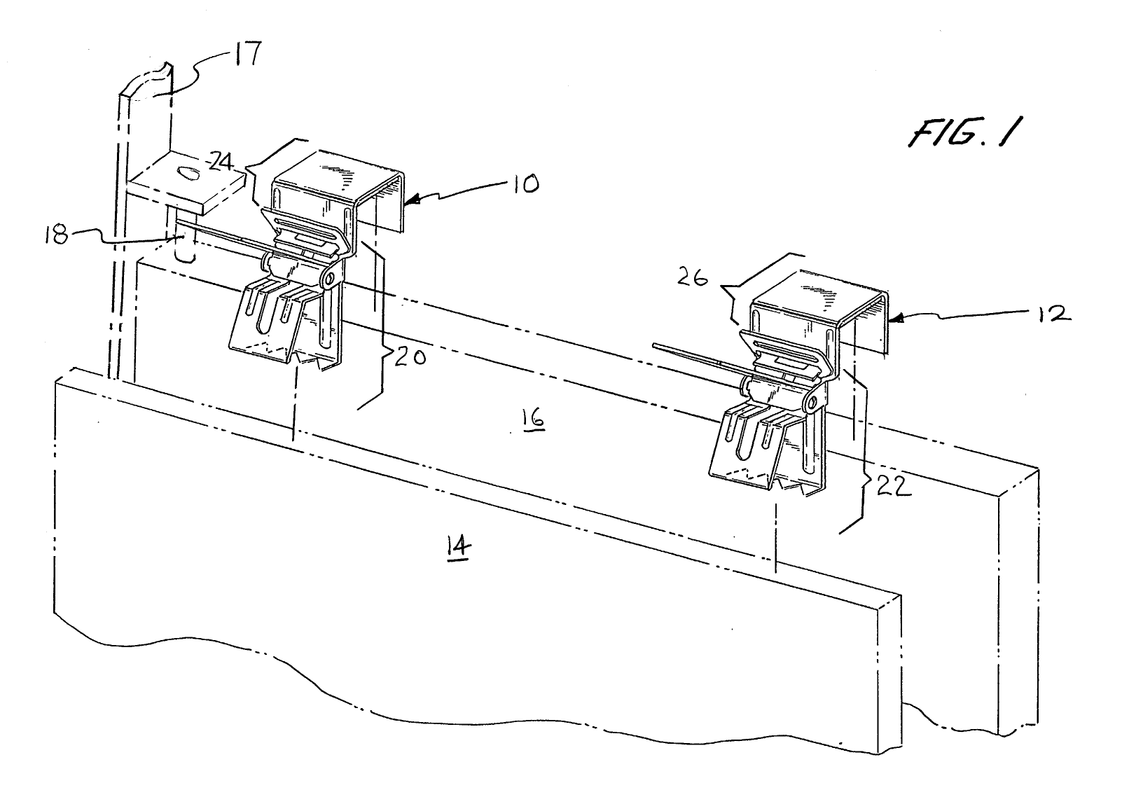

Referring to FIG. 1, two rug clips 10, 12 that have been improved in accordance with the present invention are shown poised for hanging a rug 14 on a door 16 of a display rack 17. The door 16 is configured to pivot about hinges 18 (only one hinge is shown) of the display 17. Each clip 10, 12 includes a cam-action clipping mechanism 20, 22 and a channel-shaped bracket 24, 26.

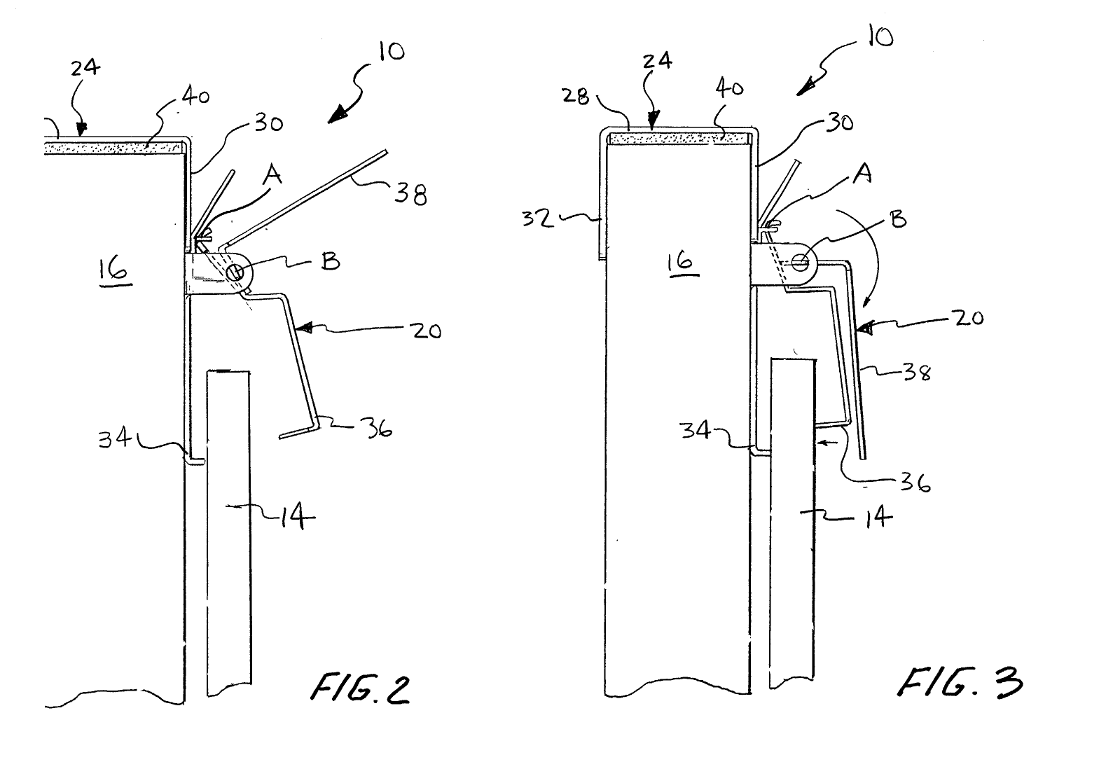

Referring to FIGS. 2 and 3, rug clip 10 is shown mounted to the door 16 of display rack 17 (not shown) and poised for clipping rug 14. The channel-shaped bracket 24 includes a top portion 28 from which a front leg 30 extends from a front edge of the top portion 28 and from which a rear leg 32 extends from a rear edge of the top portion 28. Both front leg 30 and rear leg 32 are approximately perpendicular in relation to the top portion 28.

The cam-action clipping mechanism 20 includes an inner jaw 34 which extends from front leg 30 of the channel-shaped bracket 24. An outer jaw 36 is configured to pivot about pivot-point “A” and mate with the inner jaw 34 to clamp rug 14. A cam arm 38 is configured to contact outer jaw 36 and pivot about pivot-point “B” in a clock-wise direction in order to cause outer jaw 36 to move toward inner jaw 34, thereby gripping rug 14 there between.

The channel-shaped bracket 24 and clipping mechanism 20 may be made of, for example, plain steel, stainless steel, or plastic. An embodiment of the invention wherein the channel-shaped bracket 24 and the clipping mechanism 20 are made of plain steel should also include a coating material on the plain steel (e.g., galvanize) in order to prevent oxidation.

Those of ordinary skill in the art will appreciate that clipping mechanisms other than the specific one described herein above may be utilized in the present invention. For example, the spring-action clamp disclosed in U.S. Pat. No. 2,633,321 may be used in place of clamping mechanism 20 to grip rug 14. The spring-action clamp disclosed therein includes opposed jaw members 16, 18 pivotally secured to each other by a pin 24 and biased to a closed position by a coil spring 26.

In order to prevent the rug clip 10 from slipping along the top edge of the door 16, a non-slip material 40 is attached to the bottom surface of the top portion 28 of the channel-shaped bracket 24. The non-slip material 40 may be any material having a coefficient of friction sufficient to prevent the rug clip 10 from slipping along the top of the door 16 when it is swung about its hinges 18. Useful non-slip materials include, for example, natural rubber, butyl, EPDM, hypalon, neoprene, and nitrile (buna-n).

The non-slip material 40 may be attached to the rug clip 10 in any number of ways including, but not limited to, adhesion and riveting. Alternatively, the non-slip material 40 may be mechanically captured by, for example, flanges extending from the top portion 28 of channel-shaped bracket 24 and crimped onto the non-slip material 40 (not shown) or the non-slip material 40 may include molded-in tabs that interlock with cutouts in one or more of the top portion 28, the front leg 30, or the rear leg 32 of channel-shaped bracket 24 (not shown). Attaching non-slip material 40 to a rug clip essentially eliminates the above-described disadvantage, that is, it prevents the rug clip from slipping when the door 16 of the display rack 17 is swung about its hinges 18.

While the invention has been described with respect preferred embodiments, those skilled in the art will readily appreciate that various changes and/or modifications can be made to the invention without departing from the spirit and scope of the invention as defined by the appended claims.

What is claimed is:

1. A rug clip for hanging a rug from a door of a display rack, the rug clip comprising:
a channel-shaped bracket including a top portion having a bottom surface, a front leg extending from a first edge of the top portion, and a rear leg extending from a second edge of the top portion opposite the first edge, wherein the front leg and the rear leg are approximately perpendicular in relation to the top portion;
a clipping mechanism mounted to the front leg for gripping the rug; and
a non-slip material attached to the bottom surface of the top portion.

2. A rug clip as recited in claim 1, wherein the clipping mechanism is a cam-action clipping mechanism including an inner jaw extending from the front leg, an outer jaw pivotally attached to the front leg and configured to engage the inner jaw to grip the rug, and a cam arm pivotally attached to the front leg for engaging the inner jaw and the outer jaw.

3. A rug clip as recited in claim 1, wherein the clipping mechanism is a spring-action clipping mechanism including opposed jaw members pivotally secured to each other and biased with a coil spring to cause the jaw members toward engagement for gripping the rug.

4. A rug clip as recited in claim 1, wherein the channel-shaped bracket and the clipping mechanism are made of stainless steel.

5. A rug clip as recited in claim 4, wherein the channel-shaped bracket and the clipping mechanism are made of galvanized plain steel.

6. A rug clip as recited in claim 1, wherein the non-slip material is selected from natural rubber, butyl, EPDM, hypalon, neoprene, and nitrile.

7. A rug clip as recited in claim 1, wherein the non-slip material is attached to the bottom surface of the top portion with an adhesive.

8. A rug clip as recited in claim 1, wherein the non-slip material is attached to the bottom surface of the top portion by mechanical means.

9. A rug clip as recited in claim 1, wherein the non-slip material includes one or more tabs molded therein that engage with slots in the channel-shaped bracket in order to retain the non-slip material in position on the bottom surface of the top portion.

10. A rug clip as recited in claim 1, further including flanges extending from the top portion, wherein the flanges are crimped onto the non-slip material in order to retain the non-slip material in position on the bottom surface of the top portion.

11. A rug clip for hanging a rug from a door of a display rack, the rug clip comprising:
a channel-shaped bracket including a top portion having a bottom surface, a front leg extending from a first edge of the top portion, and a rear leg extending from a second edge of the top portion opposite the first edge, wherein the front leg and the rear leg are approximately perpendicular in relation to the top portion;
a cam-action clipping mechanism mounted to the front leg for gripping the rug, the cam-action clipping mechanism including an inner jaw extending from the front leg, an outer jaw pivotally attached to the front leg and configured to engage the inner jaw to grip the rug, and a cam arm pivotally attached to the front leg for engaging the inner jaw and the outer jaw; and
a non-slip material attached to the bottom surface of the top portion.

12. A rug clip as recited in claim 1 1, wherein the channel-shaped bracket and the cam-action clipping mechanism are made of stainless steel.

13. A rug clip as recited in claim 11, wherein the channel-shaped bracket and the cam-action clipping mechanism are made of galvanized plain steel.

14. A rug clip as recited in claim 11, wherein the non-slip material is selected from natural rubber, butyl, EPDM, hypalon, neoprene, and nitrile.

15. A rug clip as recited in claim 11, wherein the non-slip material is attached to the bottom surface of the top portion with an adhesive.

16. A rug clip as recited in claim 11, wherein the non-slip material is attached to the bottom surface of the top portion by mechanical means.

17. A rug clip as recited in claim 11, wherein the non-slip material includes one or more tabs molded therein that engage with slots in the channel-shaped bracket in order to retain the non-slip material in position on the bottom surface of the top portion.

18. A rug clip as recited in claim 11, further including flanges extending from the top portion, wherein the flanges are crimped onto the non-slip material in order to retain the non-slip material in position on the bottom surface of the top portion.
